(19) United States
(12) Patent Application Publication
(10) Pub. No.: US 2010/0100967 A1
(43) Pub. Date: Apr. 22, 2010

(54) SECURE COLLABORATIVE ENVIRONMENT

(76) Inventors: JAMES E. DOUGLAS, San Diego, CA (US); Charles R. White, Charles Town, WV (US); Melvin D. Satterwhite, JR., Gainesville, VA (US)

Correspondence Address: PATENT GROUP;C/O DLA PIPER US LLP, 203 N. LASALLE ST., SUITE 1900, CHICAGO, IL, 60601, US

(21) Appl. No.: 12/475,028

(22) Filed: May 29, 2009

Related U.S. Application Data
(63) Continuation-in-part of application No. 12/142,232, filed on Jun. 19, 2008.
Application No. 12/142,232 is a continuation-in-part of application No. 11/824,694, filed on Jul. 2, 2007.
Application No. 11/824,694 is a continuation-in-part of application No. 11/257,421, filed on Oct. 24, 2005.
Application No. 11/257,421 is a continuation-in-part of application No. 11/077,948, filed on Mar. 11, 2005.
Application No. 11/077,948 is a continuation-in-part of application No. 10/892,584, filed on Jul. 15, 2004, now Pat. No. 7,676,834.

(51) Int. Cl. G06F 21/00

(52) U.S. Cl. 726/27; 726/26

(57) ABSTRACT

A secure collaborative environment to facilitate the sharing of confidential information between organizations, which can be used in conjunction with existing infrastructure.

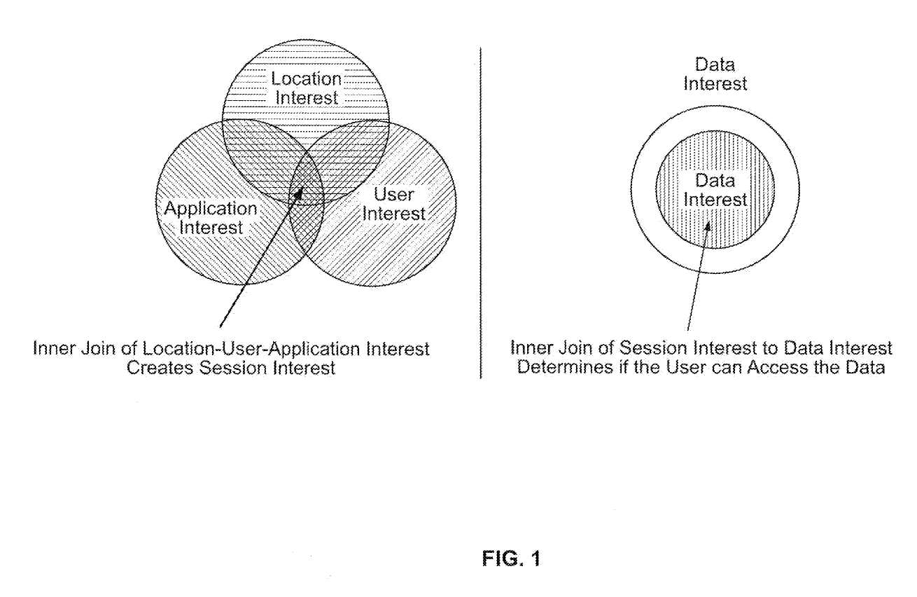

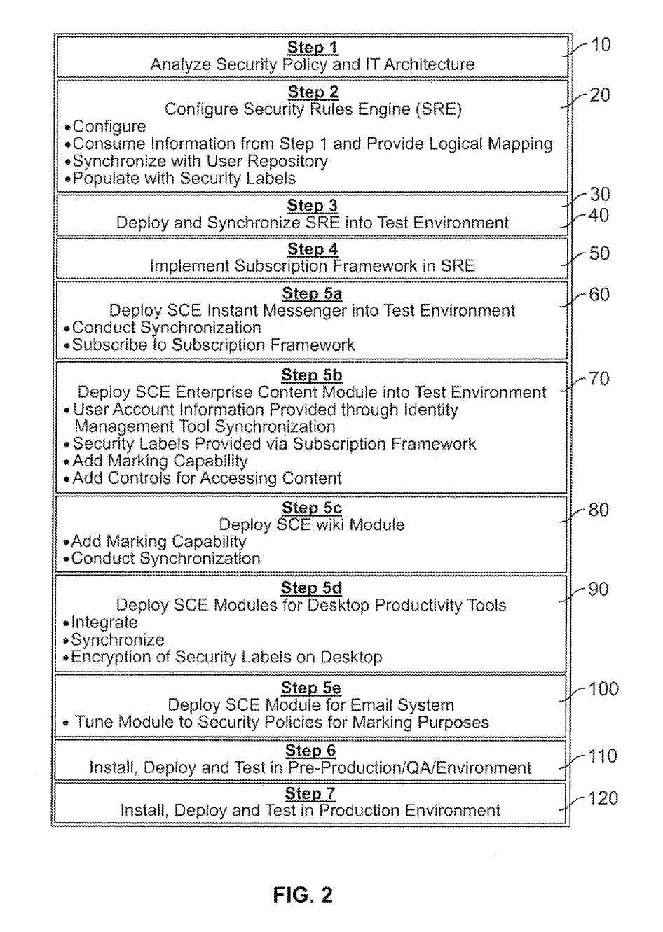

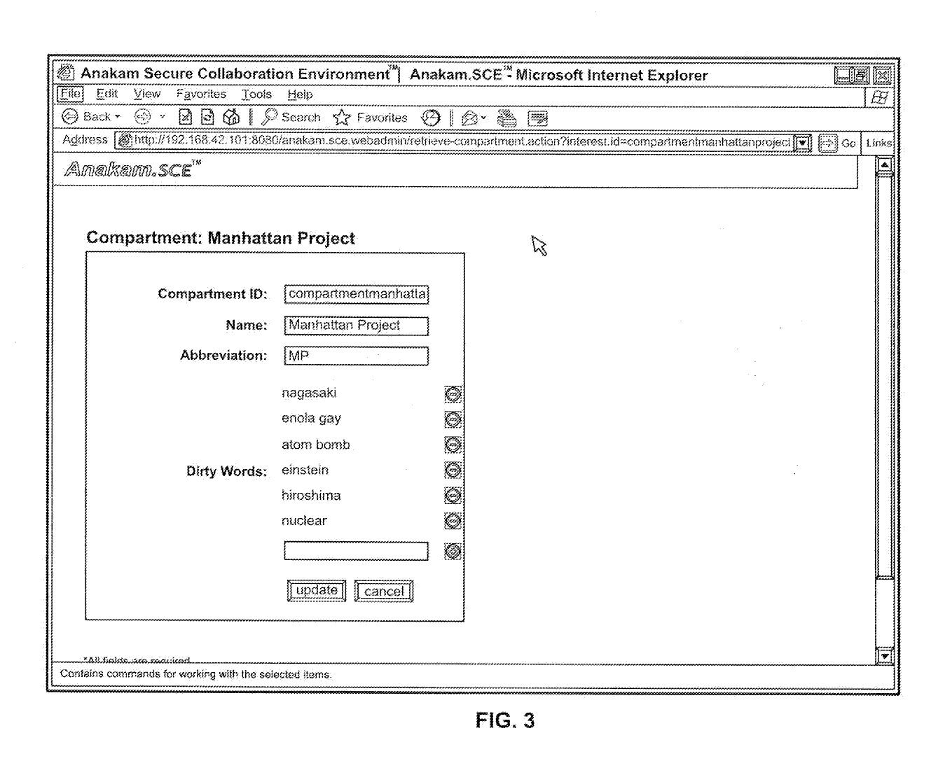

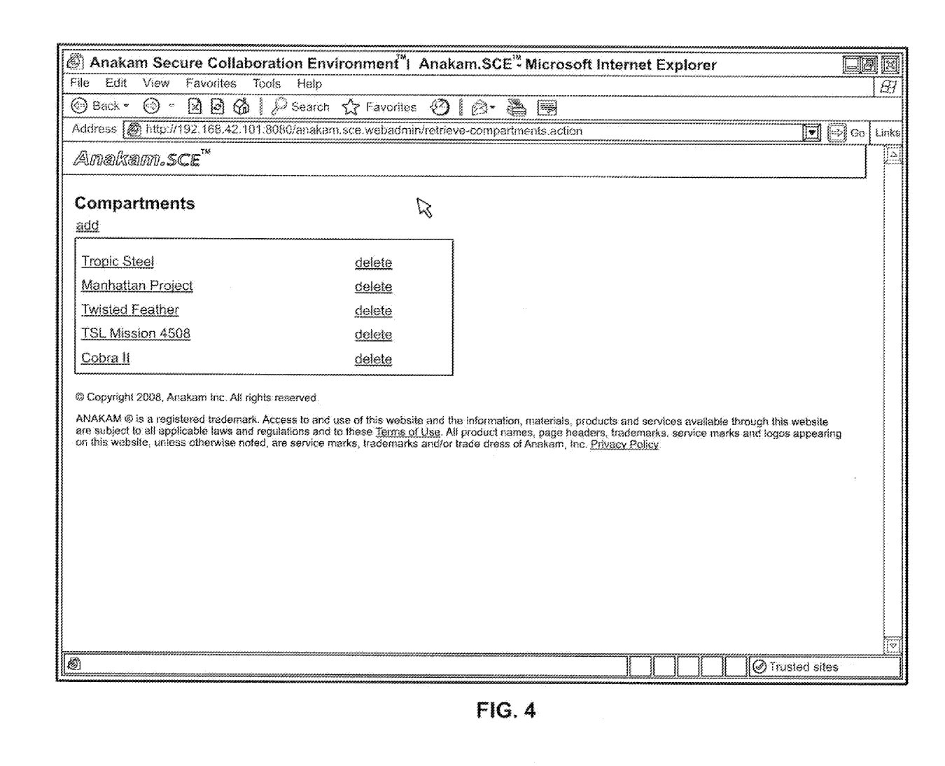

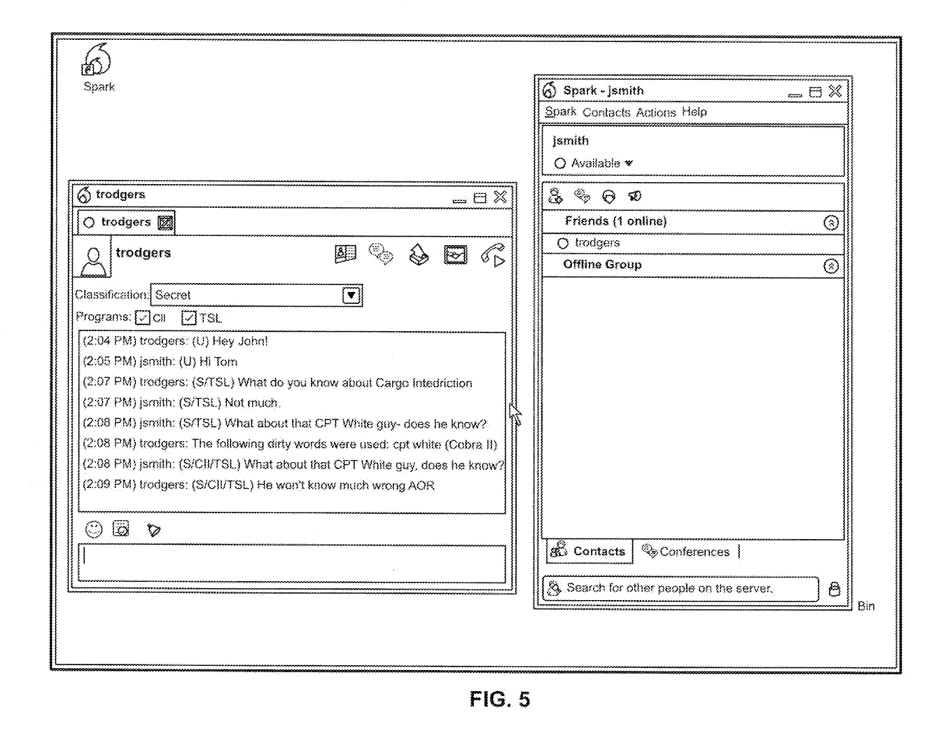

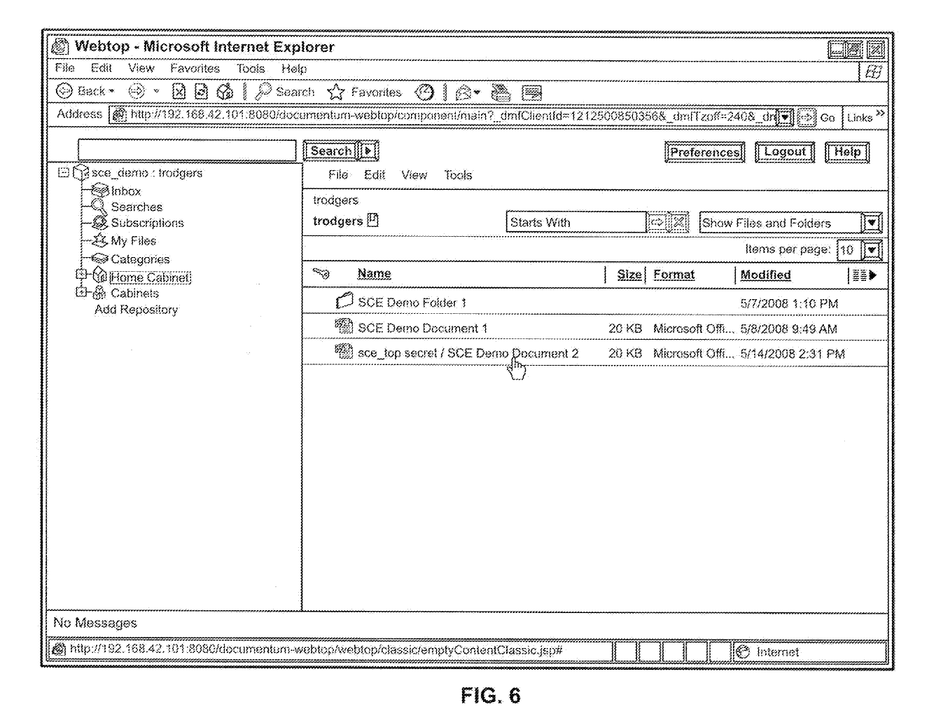

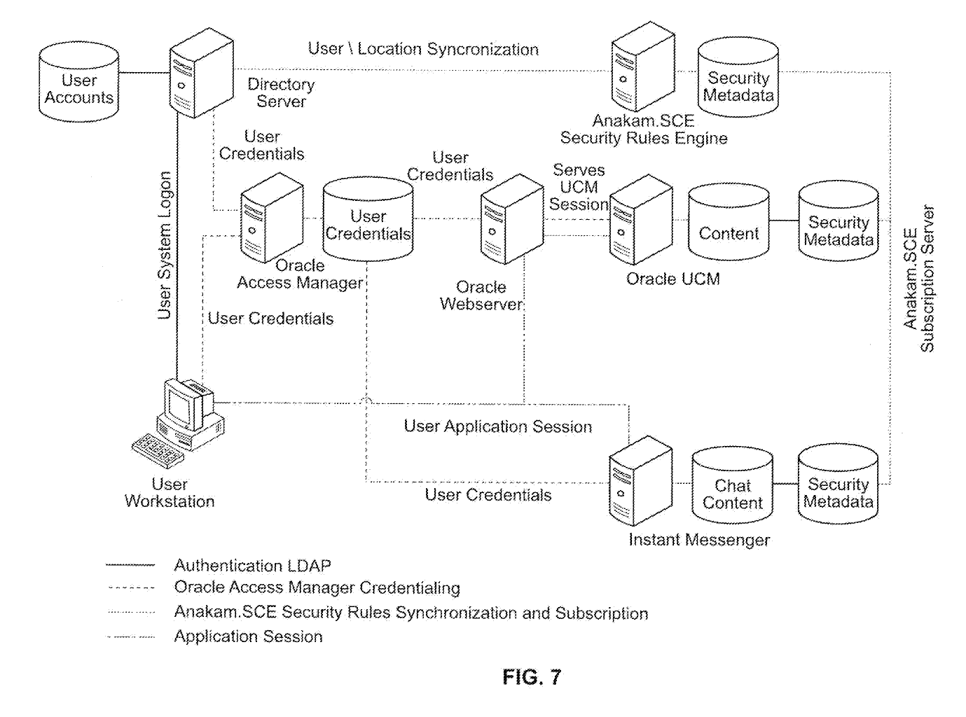

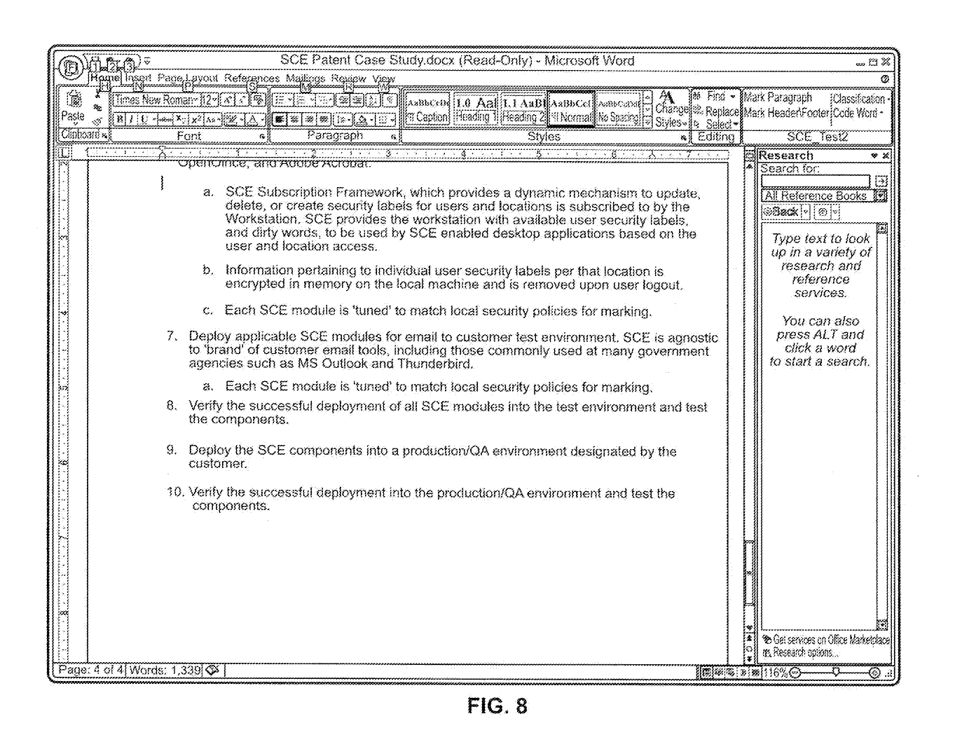

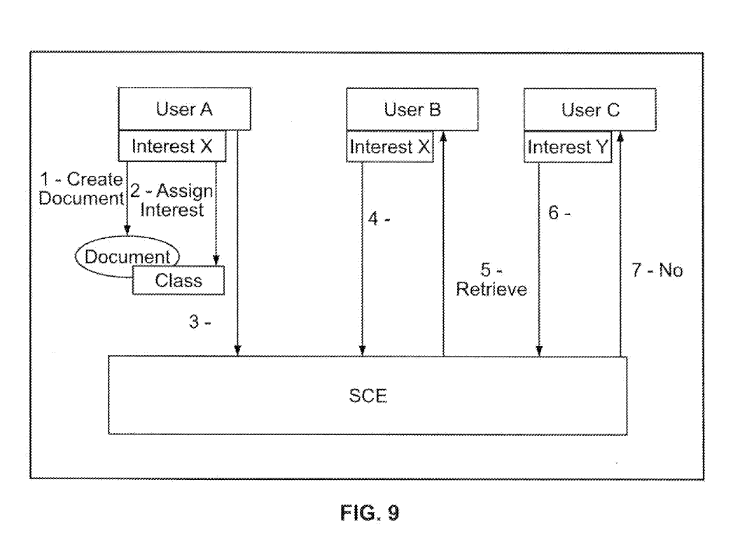

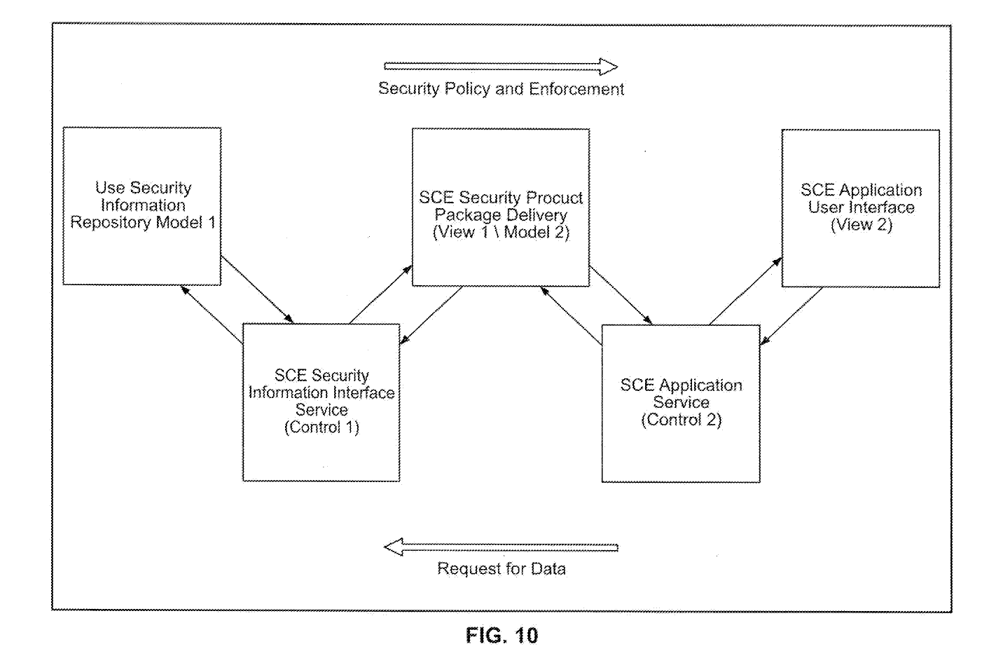

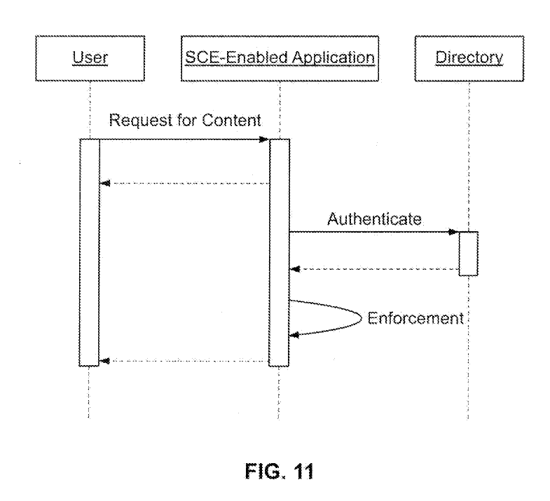

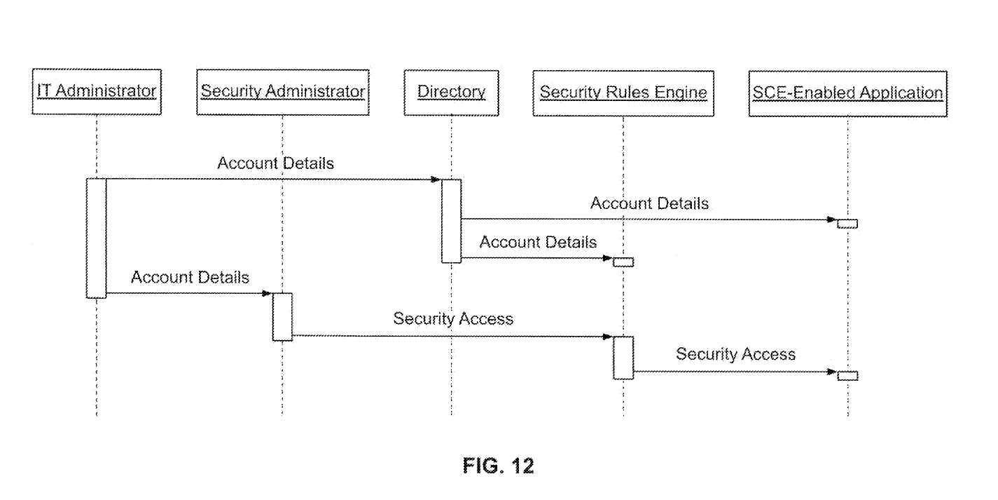

### RELATED APPLICATIONS

This application is a continuation-in-part of and claims priority from 12/142,232 filed Jun. 19, 2008, which is a continuation in part of U.S. patent application Ser. No. 11/824,694, filed Jul. 2, 2007, which is a continuation-in-part of U.S. patent application Ser. No. 11/257,421, filed Oct. 24, 2005, which is a continuation-in-part of U.S. patent application Ser. No. 11/077,948, flied Mar. 11, 2005, which in turn is a CIP of Ser. No. 10/892,584, filed Jul. 15, 2004, all of which are incorporated herein by reference and from all of which is priority claimed.

### FIELD OF THE INVENTION

The systems, methods, and graphical user interfaces disclosed herein relate to communications generally, and more specifically to a Secure Collaborative Environment comprising a Security Rules Engine in which access to secure information is granted or denied based on the application of an organization's security policy. The security policy may include authorization criteria for users, physical and logical access locations, and computing applications, as well as descriptive security details of the target information. The Security Rules Engine interprets and enforces the security policy to appropriately allow, restrict, or deny access to information and interaction between users.

The present invention provides the means to utilize web services and application modifications to apply authorization based access control to items (users, facilities, data, and applications) by security specific interest in secure data networks by establishing programmatic mechanisms that compare items based on a union of item accesses. Additionally the invention provides a subscription framework to provide real-time updates for security specific interests for users, facilities and applications in secure data networks. In one embodiment, the present invention may comprise a secure Instant Messaging function. This system integrates the Security Rules Engine into the customary instant messaging paradigm, allowing the organization's security policy to be applied to instant messaging by appropriately allowing, restricting, or denying access to instant messages and communication between users.

In another embodiment the present invention may comprise a secure wiki system. This system integrates the Security Rules Engine into the known wiki paradigm, allowing security policy to be applied to wiki entries by appropriately allowing, restricting, or denying access to wiki content and communication between users.

In another embodiment the present invention may comprise a Secure Blog system. This system integrates the security rules engine into the known blog paradigm, allowing security policy to be applied to blogging by appropriately allowing, restricting, or denying access to blog entries and communication between users. These three factors (instant messaging, wiki, and blog) may well be present on the same embodiment as is desired or in desired combination.

### BACKGROUND OF THE INVENTION

Collaborative tools are an integral part of commercial business and government operations, facilitating communication through organized information sharing, rapid information access, and real-time information availability. Across both commercial and government organizations, information is commonly made available and on a “need to know” or other similar basis in order to help prevent the compromise of sensitive information. Projects of all scales require a degree of collaboration among participants, whom may span across multiple organizations. With a myriad of different participants, each of whom with their own particular need to know, there arises the need to provide a secure, adaptable environment in which participants can share potentially sensitive information.

Numerous known approaches exist to collaboration including email, teleconferencing, video conferencing, and File Transfer Protocol (FTP). While these solutions do much to facilitate communication and information sharing, they do little or nothing to enforce security.

There, thus, is a need for a well-developed, widely acceptable system with the capacity to dynamically interpret and implement the security policy of commercial and government organizations in a collaborative environment. This has led to the development of numerous one-off solutions, none of which scale to the usability and compatibility extents necessary for widespread adoption. These systems typically require significant administrative overhead and are time-consuming to maintain. They often rely mainly or entirely on the auditability of information access to enforce security policy and limit access to information, significantly limiting their ability to provide a real time information exchange. Existing secure collaboration products are therefore either point solutions limited to a single operating system, desktop applications, enterprise content management (ECM) systems, or stovepipe systems that segregate data into common user groups, minimizing the ability for users to collaborate and share information across groups.

The prevalence of collaborative tools combined with the insufficient means of securing collaboration presents a security risk so severe that collaborative tools are prohibitively expensive to secure, or are simply not used. This results in both loss of security and loss of the ability to collaborate. Thus, there is a need for a better SCE that solves these problems.

### SUMMARY OF THE INVENTION

Aspects of the systems, methods, and user interfaces disclosed herein comprise a Secure Collaborative Environment that is integrated into an existing organization's infrastructure to allow secure information sharing by prohibiting access to information to those users whom do not have a “need to know.” The systems, methods, and user interfaces disclosed herein may be implemented in existing collaborative software environments as well as future collaborative software environments.

The Secure Collaborative Environment (SCE) of the present invention is a security framework that is integrated into an existing collaborative environment in order to facilitate secure compartmented information sharing. Its use in document management systems, typically referred to as Enterprise Content Management (ECM) systems, leverage the inherent ECM benefits and capabilities while adding integrated security policy enforcement and management. The SCE ensures that information is available only to those who are allowed to view it and only at locations they are allowed to view it from by enforcing the appropriate entity security policy at the object level.

By using such a system users are provided with the ability to easily create and share sensitive information in a controlled, audited and appropriate manner. This information is protected by prohibiting unauthorized access as governed by a user's “need to know” while at the same time maximizing the ability of the users to collaborate, thereby recognizing and encouraging the required “responsibility-to-share” that is necessary in collaborative ventures.

Another fundamental of the SCE is abstraction of interests and items. SCE capabilities define clearances, programs, and handling instructions as interests. In practice an interest can be considered a security label. An item is defined as a user, location, system, and application and has an interest or set of interests associated with it. In the simplest case, access is the process where the interest of items is compared and access is granted based on the logical union of the interests of items. If the interest of the first item is equal to or greater than the interest of the item being accessed than access is granted.

A more realistic case is defined as follows. As shown in Figure One, the interest of a user, location, and application is compared. The union of those interests is compared to the interest of a file. If the union of interest from the user-location-application to the file is sufficient then access is granted to the user at that location with the application accessing the file.

The Secure Collaborative Environment described and disclosed herein is agnostic to the platform on which it is used, and can be used in conjunction with various desktop productivity tools such as Microsoft Office, Open Office, and Adobe Acrobat; email tools such as Microsoft Outlook and Thunderbird; web browsers such as Internet Explorer and Firefox; Operating Systems such as Windows, UNIX, and LINUX; and ECM solutions such as Open Text Livelink, EMC² Documentation, and Oracle Universal Content Management (UCM) system, as well as open source collaboration tools such as Drupal.

Additionally, the SCE disclosed herein can be used in conjunction with automated tools such as wikis, XMPP-based (also known as Jabber-based) instant messaging/secure chat systems, secure blogs, and other processes that improve productivity for users and administrators.

The SCE disclosed herein also can be used with ECM systems to leverage inherent ECM benefits and capabilities while adding integrated security policy enforcement and management. Its can be integrated with a user's desktop software to assist and enforce proper sensitivity marking and identification of documents that users are manipulating. The SCE ensures that information is sent only to those users that are allowed to view it and only at locations at which they are allowed to view it by initiating security policy at the object level.

Moreover, the SCE disclosed herein implements an organization's security policy at the object level through the installation of a Security Rules Engine, as described in more detail below.

The SCE disclosed herein also provides automated security tools for document and email security marking and “dirty word” searches. In this context a “dirty word” is a word, phrase, expression or concept that requires security control based on the organization's security policy and is detected by pattern recognition algorithms. This automation of policy and functionality minimizes the user's responsibility of focusing on security policy. It also separates information technology administration from information assurance/security administration, allowing for rigorous certification and accreditation such as Director of Central Intelligence Directive (DCID) 6/3 Protection Level 4. In this context certification is a measure of the effectiveness of the technical and non-technical security features within or supporting the information system. Accreditation is a formal declaration by an organization that an information system is approved to operate in a particular security mode using a prescribed set of safeguards at an acceptable level of risk. DCID 6/3 establishes the security policy and procedures for storing, processing, and communicating classified U.S. intelligence information in information systems:

Yet another aspect of the methods and systems disclosed herein is the abstraction of interests and items. An interest is a clearance, program, handling instruction, or other criteria related to defining security. An item is a user, location, system, or application. Interests are applied to items to determine whether access is allowed. In the simplest case, access is the process where the interests of items are compared and access is granted based on a logical union of the interest of the items. That is, if the interest of the first item if equal to or greater than the interest of the item that is being accessed, then the access is granted.

### BRIEF DESCRIPTION OF THE DRAWINGS

Aspects of the present invention are illustrated by way of example, and not by way of limitation, in the accompanying drawings in which like reference numerals refer to similar elements. In some instances structures and devices that are known in the art are shown in block form for simplicity's sake. In these drawings:

Figure One depicts the relationship between abstracts and interest.

Figure Two depicts the steps required to implement the Secure Collaborative Environment (SCE).

Figures Three and Four provides SCE Security Rules Engine (SRE) Graphical User Interface (GUI) screen shot examples.

Figure Five provides an SCE Instant Messenger (IM) screen shot example.

Figure Six provides an SCE document control screen shot example.

Figure Seven is a drawing depicting the components of an SCE enabled IM and Enterprise Content Management (ECM) system—in this case Oracle Universal Content Manager—deployment.

Figure Eight depicts the integration of SCE with a desktop application—in this case Microsoft Office 2007.

Figure Nine shows how the SCE ECM service determines the range of information that a user is permitted to access.

Figure Ten shows how a Nested Model-View-Controller (NMVC) design pattern is utilized for SCE functionality.

Figure Eleven is a cross functional flowchart demonstrating how content is accessed.

Figure Twelve is a cross functional flowchart demonstrating how account management is accomplished.

### DETAILED DESCRIPTION

A Secure Collaborative Environment (SCE) is described herein. In the following description, illustrative examples are provided for purposes of explanation and are not intended to be limiting. Numerous details are provided but it will be apparent that aspects of the present invention can be practiced without these specific details or in other appropriate and suitable ways.

The system, method, and user interface of aspects of the present invention will be disclosed generally through explanation of a typical SCE deployment, for illustrative purposes only. Obviously requirements vary based on an agency's or organization's specific security policies and information technology architecture, but the example below is representative of a general implementation.

The primary steps typically taken during an SCE implementation are shown in Figure Two and described as follows.

First, at 10, the customer's existing Security Policy and Information Technology (IT) architecture is analyzed. This provides a foundation for populating the Security Rules Engine (SRE) of the SCE and allows for the development of basic work flows that represent the customer's business environment.

The SCE SRE, which provides a framework for defining and implementing an agency's security policy, is next configured for the specific customer environment based on organizationally specified sensitive words whose dissemination needs to be controlled. See 20. Through this configuration process, the SRE allows enabled applications to search for these patterns of fragments, words, expressions and phrases as a method of data spill prevention, i.e. preventing the unintentional release of secure information into an insecure environment.

The Security Rules Engine provides a logical mapping of user security labels to user accounts for consumption of enabled applications. Security labels are assigned for all “dirty words” which are words, phrases or regular expressions that directly relate to the security label. The SCE enabled applications have the ability to search content for “dirty words” and restrict or deny transmittal of content based on “dirty words”.

The SRE is populated with the organization's users and locations through synchronization with the organization's user repository. The user repository is generally a database that is embodied via a tool such as a Lightweight Directory Access Protocol (LDAP) repository. The Security Rules Engine uses network items in the form of Internet Protocol (IP) ranges, device tokens, and geospatial coordinates to represent locations. The SRE uses application names to represent organization applications.

The Security Rules Engine is populated with the previously mentioned security labels (classifications, compartments, personal health information tags, etc.) to represent attributes which form a means for marking and controlling content within SCE enabled applications. The SRE provides interfaces to apply security labels to users, locations, and applications for the enforcement of access control. Access control is the mechanism by which services know whether to honor or deny access requests. Authorization in this context is the means of expressing access policy by explicitly granting a right of an entity to access the resource based on security attributes (interests) that are designated for the given customer environment in the form of security labels.

Next, at 30, the Security Rules Engine is deployed into a customer test environment that simulates its operational environment, before actually being implemented into the actual environment. This step consists of implementing the associated rules and processes of the customer security policy within the SRE Administrative Graphical User Interface (GUI). The SRE Admin GUI is the conduit for the user to implement customer security policy into the SRE. Figures Three and Four demonstrate interfaces for establishing and manipulating a security attribute (in this case a Compartment). Figure Four specifically demonstrates an interface for deleting Compartments from the Security Rules Engine. The SRE in turn provides a method of interpreting customer security policy in order to implement customer security policy with SCE enabled applications.

Customers use the Security Rules Engine via the SRE Admin GUI to assign security labels to users, locations and applications and to assign security controls into their environment based on those labels. The Security Rules Engine shows customer security policy in a logical form that can be implemented by SCE enabled applications as a method of Authorization Based Access Control which can work in tandem with an existing user Role Based Access Control mechanism—usually through an implementation of LDAP.

Next, at 40, after the Security Rules Engine is shown to meet administrative and operational requirements in the test environment, the SRE is synchronized with the customer SRE environment. User account and security information is typically managed by Identity Management tools such as Oracle Access Manager. This information is consumed by the SRE through a customizable synchronization connecter. The connecter is matched to the specific identity management tools employed in the customer environment and, by adhering to a common interface for representing and sharing security information, enables synchronization with the SRE through a simple mapping of the customer security model.

SRE location association is established by IP address, device tag, or geospatial coordinates for the customer environment. User locations are mapped to program accesses through the Security Rules Engine for consumption of enabled applications through the SCE Subscription Framework, which synchronizes real-time security information between the SCE SRE and SCE-enabled applications.

Next, at 50, the SCE Subscription Framework is implemented. It provides a dynamic mechanism to update, delete, or create security labels for users and locations for SCE enabled applications, and is implemented in the existing customer environment. The Subscription Framework is implemented in SCE application modules and the Security Rules Engine. These services propagate real-time changes to published security products. The Subscription Framework is the mechanism in which SCE enabled applications consume security labels, users, locations, and applications from implementation of customer security policy. Appendix A is a sample listing of codes the SCE Subscription Framework, written in Java that can be used for a variety of SCE enabled applications that support Java.

Auditing and audit reduction for the Security Rules Engine are also provided. Audit reduction provides customers with a specific view of SCE audit information determined on criteria such as applications, users or locations for the purpose of a targeted search of SCE.

Next, at 60, an SCE XMPP-based Instant Messenger (IM) feature may be deployed into the customer test environment. The SCE Instant Messenger is a real time communications tool that implements customer security policy based on security rules applied to users, and locations within the SCE Security Rules Engine. Appendix B includes code for implementation of the SCE IM.

As is seen in Figure Five, SCE IM provides current user and facility information through the Subscription Framework. When a user starts an SCE IM client, it initially contacts the SRE, and requests a subscription to the user's security information. This information, which includes the secure channels to which the user has access, allows the SCE IM client to enforce marking of outgoing data, as well as prevents data leaks to destinations with insufficient security channels. The subscription is kept up to date in real time, so any changes to the user's security channels in the SRE will be propagated to and updated in the SCE IM client while it is in use.

The SCE IM is synchronized with the customer environment through its own LDAP (or comparable software) synchronization mechanism. User account information is provided through Oracle Access Manager (or comparable software) synchronization with the Instant Messenger. Users are provided with the ability to mark outgoing chat based on their current access. Additionally users have “dirty word” pattern recognition searches conducted against message traffic to ensure that inappropriate information is not sent to recipient(s). The SCE IM message traffic is encrypted at the transport level via Transport Layer Security (TLS) encryption or any other appropriate encryption.

The SCE Subscription Framework, which provides a dynamic mechanism to update, delete, or create security labels for users and locations for SCE IM, is subscribed to by SCE IM in the customer environment. The Subscription Framework provides real-time updates to user access to the SCE IM client and to the SCE IM server through subscriptions to interest and item services. Auditing and audit reduction for the secure Instant Messenger are also normally provided.

Next, at 70, the SCE module for the ECM solution chosen by the customer is deployed into the test environment. The SCE of the present invention is agnostic to the ‘brand’ of customer document management tools, including those commonly used at many government agencies and corporations such as Open Text Livelink, EMC² Documentum, and Oracle Universal Content Management (UCM) system—as well as open source collaboration tools such as Drupal. An example screen shot of an EMC² Documentum implementation is shown in Figure Six. This figure demonstrates the Documentum Graphic User Interface with content marked with security attributes—in this case classifications and code words. This marking is enforced with Security Controls which are part of the SCE module for Documentum.

As shown in Figure Seven, user account information is provided through Oracle Access Manager (OAM) (or equivalent Identity Management tool) synchronization with Oracle UCM (the ECM tool chosen for this deployment example). Users are able to view, modify, and create content in Oracle UCM based on authentication from OAM and access control services through SCE. Oracle Access Manager provides user authentication credentials for Oracle Universal Content Management where as SCE provides a method of assigning security attributes and controlling content access in Oracle UCM based on those security attributes.

The SCE Subscription Framework is the mechanism in which the SCE Enabled Application server—in this example an Oracle Universal Content Management server—is provided security labels for users and locations as defined in the Security Rules Engine. By virtue of this process, table schemas are implemented for SCE Labels, users are able to mark content based on their current access (a union of user, location, and application access), users who do not have appropriate access are unable to view or modify content in which they do not have access, and data at rest is encrypted. Having users denied access as a result of having insufficient access enforces authorization based access control. Encrypting the data at rest provides a mechanism of protecting the data from exploitation from malicious users and provides compliance for customer security policy. The logon process does not change from a user perspective.

What does change is the user's experience with Oracle UCM. The user logs into the environment utilizing Oracle Access Manager as a method of providing user and password information to the Oracle UCM server. The SCE Module for Oracle UCM has been configured to allow or deny access to content stored on the Oracle UCM Server based on user and location security labels. Oracle UCM now has the ability to label content and search uploaded content for “dirty words” based on user and location access. It then advises the user on appropriate courses of action (re-label or not upload). The user information for the session is supplied by Oracle Access Manager and the location is taken from the requesting IP address of the user workstation.

Further, a marking capability is added through the SCE ECM module. Marking for classification banners is added based on the user's highest classification or program access allowed and based on available content marking on current folder, project, and/or cabinet.

Controls are also added for accessing ECM content. Controls include location sensitivity. These controls can allow, deny, or reduce access based on the organization security policy. Users can further modify associated ECM collaboration tools for SCE. The document control mechanism may be an SCE module which is a part of the content management solution. This SCE module provides an interface for the Subscription Framework to receive information as described previously from the Security Rules Engine. Additionally this module controls access to the content within the system based on the information provided by the Security Rules Engine. This control results in reducing, restricting or allowing access based on the logical union of user, location, and application security labels in comparison to the security label of the content. Additionally content being uploaded into the content management solution is scanned for dirty words and content transmission is restricted or denied based on dirty words existing in the content presented to the content management solution. Restriction of transmission of content to the content management solution includes giving the user the option to apply appropriate security labels to the content based on the logical union of user, location, and application authorized security labels. If the user does not have appropriate access as defined as the logical union of user, location, and application security labels, then the user will not be able to access content within the content management system that has security labels that are not part of the logical union of user, location and application security labels.

It should also be noted that the SCE Subscription Framework provides a dynamic mechanism to update, delete, or create security labels for users and locations as subscribed to by the SCE ECM module through subscriptions to interest and item services. SCE provides Oracle UCM with current user and facility information through the SCE Subscription Framework. The Subscription Framework provides real-time updates to user access to the UCM server. Auditing and audit reduction is provided for the SCE module for UCM.

An SCE wiki module may also be deployed, 80, to the customer test environment. This SCE wiki module may be ECM or a stand-alone wiki tool based. A wiki in this context is a page or collection of web pages designed to enable anyone who accesses it to contribute or modify content, using a simplified markup language. Wikis are often used to create collaborative websites. Some Enterprise Content Management systems incorporate wikis into their feature set. The SCE is designed to work with either these ECM wiki tools or stand alone tools available in the commercial marketplace.

Marking capability is added through the SCE wiki module. In one embodiment, ECM wiki information access and marking is paragraph based. Information is viewable based on user's highest classification/program access; each browse event requires the creation of banners on current wiki paragraph and page marking.

The SCE Subscription Framework, which provides a dynamic mechanism to update, delete, or create security labels for users and locations, is subscribed to by the SCE wiki module through subscriptions to interest and item services. SCE provides Oracle UCM with current user and facility information through the SCE Subscription Framework. The Subscription Framework provides real-time updates to user access to the UCM server. Auditing and audit reduction is provided for the SCE client for UCM.

In the case of a standalone SCE wiki tool, the wiki is synchronized with the customer environment through its own LDAP synchronization mechanism. User account information is provided through the synchronization of Oracle Access Manager with the wiki, or by any other suitable mechanism.

Next, at 90, if desired, applicable SCE modules for desktop productivity tools are deployed to the customer test environment. By adhering to a common model for representing and sharing security information, SCE is agnostic to the ‘brand’ of customer desktop productivity tools, including those commonly used at many government agencies such as Microsoft Office, OpenOffice, and Adobe Acrobat.

As shown in Figure Eight, the SCE module is integrated into the customer's existing environment, in this case Microsoft Office 2007. This figure is an illustrative but non-limiting example of an SCE enabled Microsoft application user interface. In this case, a module has been developed that provides a mechanism for marking document content with security labels that are supplied by the Security Rules Engine through the Subscription Framework. Additionally, this module provides a mechanism for checking for “dirty words”. This is treated primarily as a marking mechanism with the controlling capabilities happening at SCE enabled application servers.

The SCE Subscription Framework, which provides a dynamic mechanism to update, delete, or create security labels for users and locations, may be subscribed to by the users' workstation, the personal computer in which a user interacts with SCE enabled server applications, through subscriptions to interest and item services. SCE provides the workstation with available user security labels and dirty words, to be used by SCE enabled desktop applications based on the user and location access. This information is encrypted in the memory of the user's workstation upon the workstation subscribing to SCE information in the Security Rules Engine.

Further, information pertaining to individual user security labels per that location is encrypted in memory on the local machine and subsequently removed upon user logout. Each SCE module is ‘tuned’ to match local security policies for marking.

Next, at 100, if desired, applicable SCE modules for email are deployed to the customer test environment. Again, by adhering to a common model for representing and sharing security information, SCE is agnostic to ‘brand’ of customer email tools, including those commonly used at many government agencies such as Microsoft Outlook and Thunderbird.

During implementation each SCE module discussed above is ‘tuned’ to match local security policies for marking. The final step is to verify the successful deployment of all SCE modules into the test environment and test the components.

At 110, the SCE components are then installed into a pre-production/Quality Assurance (QA) environment designated by the customer. This is done through installing and integrating SCE modules for enabled applications, installing the Security Rules Engine, populating the Security Rules Engine with security labels, assigning dirty words for security labels, and assigning security labels to user, locations, and applications. The complete environment is tested based on customer system requirements and a security evaluation of the environment is performed to ensure compliance with customer security policy.

Finally, at 120, the system is installed, tested, and deployed into the operational production environment.

A user session component of the present invention manages SCE application level user login and provides interfaces to determine the user's current session capabilities. This component manages SCE sign on authentication and provides user verification credentials and system privileges. The SCE user session module utilizes the existing authentication systems for user management and authentication. This existing system is a repository that maintains authorized system users. An interface between SCE and authentication system provides fundamental system access control for users attempting to access the SCE.

Once the user is authenticated, an SCE login session is established setting the interest limits available to the user for their session. The user session component monitors for changes to user privileges and provides software notification to other SCE components of required updates. A service interface allows SCE components to determine a user's current session interest and privileges.

The content management or Enterprise Content Management (ECM) portal displays are modified to limit what content is displayed. Content that is presented is labeled to indicate the security interest of the content. Users are prevented from accessing information they are not permitted to access. These limits are based on the granted security interest controlled by system administrators. In addition, users are prevented from determining if information exists for which access has not granted. Users accessing the portal will have access to only information falling within their configured access privileges.

As shown in Figure Nine, when a user requests to display repository contents, the SCE ECM service determines the range of information that a user is permitted to access and limits the display to documents within that interest range. Interoperating with the SCE security services, the range of information the user is permitted to access is determined and used to limit what documents and directories can be viewed. The SCE ECM service enforces mandatory security labeling for documents stored in the repository.

Instant Messaging and Wikis are powerful tools for quickly and effectively managing and communicating information. SCE enhancements to Instant Messenger and Wikis allow users with differing interests to collaborate straightforwardly with assurances that data is distributed only to properly cleared users. The interest of each instant message is determined based on the message content when the message is sent and the message is marked with the appropriate classification. Messages are blocked for recipients without proper clearance to ensure that they do not receive information marked at that classification level. A blocked message is not delivered and a notification is provided to the sender indicating the recipient has insufficient clearance to receive a message with that marking.

SCE enhanced Wikis function much like other SCE enhanced tools. The interest of data being added to the page is determined automatically using dirty word search tools or can be manually set by the user editing the page. Wiki paragraph markings are displayed and accessible content is limited to the interest of the user's current session.

Microsoft Office, OpenOffice and Microsoft Outlook are primary user desktop productivity tools. Plug-in modules for the user applications provide built in capabilities to assist users with marking and labeling documents with proper security interest. These modules add menu options and tool bars directly to office applications including Microsoft Word, Excel, PowerPoint and Project as well as OpenOffice Writer, Calc, and Impress applications.

Document marking tools provide the capability to mark documents according to DoD 5200.1-PH, HIPAA, or user defined standards. Based on user interest selections, document headers and footers are automatically edited to include standard sensitivity markings. In addition, documents are portion marked. By default, the document is marked at the user's highest session interest; however menu options allow the user to manually select a desired classification. Users also have the option to use a dirty word search tool to automatically assign an interest or individually select sections of a document and manually change the interest for the current selection.

The markings applied by the user become the labeling used by the system to control content distribution. The marking tools make use of XML document file representation formats to provide maximum flexibility and compatibility with other software and file formats.

Users interact with Email systems such as Microsoft Outlook\Exchange using built in menu options much like working with a document. Messages are assigned a classification and are marked. When the user selects to send a message the recipient's clearance level is tested against the message classification. If the recipient is not cleared to receive the message the message is not delivered and a rejection message is sent to the sender.

Security administration tools provide an authorized administrator the capabilities to manage interests such as security levels and compartments for the Department of Defense. Tools are provided to create, update, and remove SCE security levels and compartments. These tools also provide the capability to select users, or groups of users, and specify security level and compartment assignments.

The Security Administration tool utilizes the Subscription Framework which propagates user, location and application interests through web based services that supported applications subscribe to when starting. When an enabled application starts it passes its start state to the Security Rules Engine which in turn passes user, location security metadata updates to interests for users, locations, and applications via web service to the supported application server or workstation.

A Nested Model-View-Controller (NMVC) design pattern is utilized for SCE functionality as shown in Figure Ten. Ultimately, an organization's security data repository is the model for the SCE. The following describes the steps taken:
1. Control 1, Security Information Interface, requests data from Model 1 and then interprets the returned data to provide to View 1/Model 2, the SCE Security Product Package delivery service.
2. View 1/Model 2 returns a security metadata product that is relevant for the SCE enabled application Control 2.
3. Control 2 translates the security package into relevant information for that application that is displayed via View 2, the SCE application user interface.
4. Control 1 and View 1/Model 2 represent the automation/interpretation of security policy for the SCE, whereas as Control 2 and View 2 represent the implementation of policy via an SCE enabled application.

This approach allows for the interpretation and implementation of policy to be separate in the SCE. By separating policy interpretation and implementation, application specific changes will not impact the collective behavior of the SCE. This allows aspects of the SCE to be swapped out and reconfigured based on customer needs. Additionally this allows minor policy changes to be made without significantly impacting the SCE functionality.

When a user account is formed for identification and authentication data store, such as LDAP, the Subscription Service synchronizes user account data to the Security Rules Engine much in the same way that supported applications synchronize with LDAP for single sign on. This allows security administrators to apply interests to users or locations that are defined in LDAP or apply interests to locations, and applications independent of LDAP. The subscription service applies the updated interests to enabled applications through encrypted web services to enabled applications in near real time. The cross functional flow chart depicted in Figure Eleven demonstrates the process of user account information being populated into a Directory by an IT administrator, the synchronization of user information to the Security Rules Engine, the Security Administrator applying interests to users, and the Subscription Framework populating SCE Enabled Applications with user interests. Furthermore, this demonstrates the separation of user role based access controls for applications (populated by the IT Administrator) and SCE authorization based access control (populated by the Security Administrator).

When a user requests to display contents of the enabled application, the enabled application authenticates under normal circumstances. After a valid authentication attempt the SCE ECM service determines the range of information that a user is permitted to access and limits the display to documents within that interest range. Interoperating with the SCE security services, the range of information the user is permitted to access is determined and used to limit what documents and directories can be viewed. The cross functional flow chart depicted in Figure Twelve demonstrates role based authentication for the SCE application controlled from the Directory Server, and authorization based access being controlled by the SCE Enabled Application.

It is therefore intended that the foregoing detailed description be regarded as illustrative rather than limiting, and that it be understood that it is the following claims, including all equivalents, that are intended to define the spirit and scope of this invention.

### APPENDIX A SECURITY SERVICES AND SUBSCRIPTION FRAMEWORK SOFTWARE LISTING

### A.1 SubscribableService Definition and Implementation

The SubscribableService specifies a service to be implemented by SRE services.

```
public interface SubscribableService {
    public void addSubscription(Subscription subscription);
    public void removeSubscription(Subscription subscription);
    public void updateSubscribers(Collection<String>
updatedProductIds);
}
public abstract class SubscribableServiceImpl implements
SubscribableService {
    // Maps a subscriberServiceUrls to a collection of productIds
    private Map<String, Collection<String>> subscriptions = new
HashMap<String, Collection<String>>( );
    public void addSubscription(Subscription subscription) {
        if (this.subscriptions.get(subscription.getServiceUrl( )) ==
null) {
            this.subscriptions.put(subscription.getServiceUrl( ),
                    new HashSet<String>( ));
        }
        this.subscriptions.get(subscription.getServiceUrl( )).addAll(
                subscription.getProductIds( ));
        new Thread(new SubscriberUpdater(subscription)).start( );
    }
    public void removeSubscription(Subscription subscription) {
        this.subscriptions.remove(subscription.getServiceUrl( ));
    }
    public void updateSubscribers(Collection<String>
updatedProductIds) {
        System.out.println(“About to update subscribers. This should
be quick.”);
        for (String serviceUrl : this.subscriptions.keySet( )) {
            Collection<String> unionProductIds = new
HashSet<String>( );
            unionProductIds.addAll(updatedProductIds);
    unionProductIds.retainAll(this.subscriptions.get(serviceUrl));
            try {
                Subscription subscription = new Subscription( );
                subscription.setServiceUrl(serviceUrl);
                subscription.setProductIds(updatedProductIds);
                new Thread(new
SubscriberUpdater(subscription)).start( );
            } catch (Throwable t) {
                System.err.println(“Error updating subscriber ” +
serviceUrl
                        + “ with ids ” + updatedProductIds);
            }
        }
        System.out.println(“Done updating subscribers.”);
    }
}
```

### A.2 InterestService Definition and Implementation

InterestService is an implementation of a SubscribableService, and is a service provided by SRE services to provide Interests to subscribers. Interests in this case can be classifications, compartments, programs, etc.

```
public interface InterestService extends SubscribableService {
    public void setInterest(Interest interest);
    public Interest getInterest(String identifier);
    public void setInterests(Collection<Interest> interests);
    public Collection<Interest> getInterests(Collection<String> ids);
    public Collection<Interest> getInterests( );
    public Collection<Interest> getInterests(String type);
}
public class InterestServiceImpl extends SubscribableServiceImpl
implements
        InterestService {
    private InterestDao interestDao;
    @Override
    public void setInterest(Interest interest) {
        this.interestDao.saveInterest(interest);
        Collection<String> updatedProductIds = new
HashSet<String>( );
        updatedProductIds.add(interest.getId( ));
        this.updateSubscribers(updatedProductIds);
    }
    @Override
    public Interest getInterest(String id) {
        return this.interestDao.getInterest(id);
    }
    @Override
    public void setInterests(Collection<Interest> interests) {
        this.interestDao.saveInterests(interests);
        Collection<String> updatedProductIds = new
HashSet<String>( );
        for (Interest updatedInterest : interests) {
            updatedProductIds.add(updatedInterest.getId( ));
        }
        this.updateSubscribers(updatedProductIds);
    }
    @Override
    public Collection<Interest> getInterests(Collection<String> ids) {
        return this.interestDao.getInterests(ids);
    }
    @Override
    public Collection<Interest> getInterests( ) {
        return this.interestDao.getInterests( );
    }
    @Override
    public Collection<Interest> getInterests(String type) {
        return this.interestDao.getInterests(type);
    }
    public InterestDao getInterestDao( ) {
        return interestDao;
    }
    public void setInterestDao(InterestDao interestDao) {
        this.interestDao = interestDao;
    }
}
```

### A.3 Subscription, Subscriber, and SubscriberUpdater

A Subscriber subscribes via a Subscription to a SubscribableService. The Subscriber's Subscription is updated by a SubscriberUpdater.

```
public class Subscription implements Serializable {
    private static final long serialVersionUID = 1L;
    private String serviceUrl;
    private Collection<String> productIds;
    public String getServiceUrl( ) {
        return serviceUrl;
    }
    public void setServiceUrl(String serviceUrl) {
        this.serviceUrl = serviceUrl;
    }
    public void setProductIds(Collection<String> productIds) {
        this.productIds = productIds;
    }
    public Collection<String> getProductIds( ) {
        return this.productIds;
    }
}
public interface Subscriber {
    public void update(Collection<String> updatedProductIds);
}
public class SubscriberUpdater implements Runnable {
    private Subscription subscription;
    public SubscriberUpdater(Subscription subscription) {
        this.subscription = subscription;
    }
    private boolean updateSubscriber( ) {
        try {
            HttpInvokerProxyFactoryBean
httpInvokerProxyFactoryBean = new HttpInvokerProxyFactoryBean( );
    httpInvokerProxyFactoryBean.setServiceInterface(Subscriber.class);
    httpInvokerProxyFactoryBean.setServiceUrl(this.subscription
                    .getServiceUrl( ));
            httpInvokerProxyFactoryBean.afterPropertiesSet( );
            Subscriber subscriber = (Subscriber)
httpInvokerProxyFactoryBean
                    .getObject( );
            subscriber.update(this.subscription.getProductIds( ));
            return true;
        } catch (Throwable t) {
            System.err.println(“Error updating subscriber ” +
this.subscription.getServiceUrl( ));
            return false;
        }
    }
    @Override
    public void run( ) {
        boolean success = false;
        int attempts = 10;
        while (success == false && attempts > 0) {
            success = this.updateSubscriber( );
            attempts−−;
            try {
                Thread.sleep(5 * 1000);
            } catch (Exception e) {
                System.err.println(e);
            }
        }
    }
}
```

### A.4 Security Rules Engine Spring Configuration

This is where SRE services are tied together and published.

```
<beans>
    <bean name=“testSubscriber”
class=“com.anakam.sce.securityservices.TestSubscriber” />
    <bean name=“/TestSubscriber”
    class=“org.springframework.remoting.httpinvoker.HttpInvokerService
Exporter”>
        <property name=“service”>
            <ref bean=“testSubscriber” />
        </property>
        <property name=“serviceInterface”>
    <value>com.anakam.sce.securityservices.Subscriber</value>
        </property>
    </bean>
    <bean name=“persister”
class=“com.anakam.sce.persist.HibernateUtil”
        init-method=“populateTestData” />
    <bean id=“itemDao” class=“com.anakam.sce.persist.ItemDao”>
        <property name=“persister” ref=“persister” />
    </bean>
    <bean id=“interestDao”
class=“com.anakam.sce.persist.InterestDao”>
        <property name=“persister” ref=“persister” />
    </bean>
    <bean id=“itemService”
class=“com.anakam.sce.securityservices.ItemServiceImpl”>
        <property name=“itemDao” ref=“itemDao” />
    </bean>
    <bean id=“interestService”
class=“com.anakam.sce.securityservices.InterestServiceImpl”>
        <property name=“interestDao” ref=“interestDao” />
    </bean>
    <bean name=“/ItemService”
    class=“org.springframework.remoting.httpinvoker.-
HttpInvokerServiceExporter”>
        <property name=“service”>
            <ref bean=“itemService” />
        </property>
        <property name=“serviceInterface”>
    <value>com.anakam.sce.securityservices.ItemService</value>
        </property>
    </bean>
    <bean name=“/InterestService”
    class=“org.springframework.remoting.httpinvoker.-
HttpInvokerServiceExporter”>
        <property name=“service”>
            <ref bean=“interestService” />
        </property>
        <property name=“serviceInterface”>
    <value>com.anakam.sce.securityservices.InterestService</value>
        </property>
    </bean>
</beans>
```

### APPENDIX B INSTANT MESSENGER SOFTWARE LISTING

### B.1 AccessProvider Definition and SSAccessProvider Implementation

An AccessProvider specifies a means of retrieving an Access. An Access in this case is the type of secure information a given individual is cleared to see. An Access includes collateral classifications, compartments, programs, etc. SSAccessProvider is the SRE services implementation of an AccessProvider.

```
public interface AccessProvider {
    public Access getAccess(String username) throws
AccessUnavailableException;
}
public class SSAccessProvider implements AccessProvider {
    private Document getXML(String urlString) throws Exception {
        java.net.URL url = new java.net.URL(urlString);
        HttpURLConnection m_con = (HttpURLConnection)
url.openConnection( );
        m_con.setDoInput(true);
        SAXReader saxReader = new SAXReader( );
        Document document =
saxReader.read(m_con.getInputStream( ));
        return document;
    }
    private Document getXML(String urlString, String name) throws
Exception {
        return this.getXML(urlString + “?name=” + name);
    }
    public Access getAccess(String username) throws
AccessUnavailableException {
        SafeJiveLog.info(“About to retrieve Access for ” + username);
        HttpInvokerProxyFactoryBean httpInvokerProxyFactoryBean
= new HttpInvokerProxyFactoryBean( );
    httpInvokerProxyFactoryBean.setServiceInterface(ItemService.class);
        httpInvokerProxyFactoryBean
    .setServiceUrl(“http://localhost:46220/sre/ItemService”);
        httpInvokerProxyFactoryBean.afterPropertiesSet( );
        ItemService itemService = (ItemService)
httpInvokerProxyFactoryBean
                .getObject( );
        Item user = itemService.getItem(username);
        Access access = new Access( );
        access.setUsername(username);
        List<Classification> classifications = new
ArrayList<Classification>( );
        for (Interest interest : user.getRegard( )) {
            if (interest.getType( ).equals(“Classification”)) {
                Classification classification = new
ClassificationImpl(null,
                        null, null, null);
                classification.setName(interest.getName( ));
                classification.setCode(interest.getShortName( ));
                classification.setUniqueID(interest.getId( ));
                classification.setPrograms(new
ArrayList<Program>( ));
                classifications.add(classification);
            }
        }
        for (Interest interest : user.getRegard( )) {
            if (interest.getType( ).equals(“Compartment”)) {
                Program program = new ProgramImpl(null, null,
null, null, null);
                program.setUniqueID(interest.getId( ));
                program.setName(interest.getName( ));
                program.setCode(interest.getShortName( ));
                program.setDirtyWords(new
ArrayList<String>( ));
                program.setHandlingCaveats(new
ArrayList<HandlingCaveat>( ));
                for (String dirtyWord : interest.getTriggers( )) {
                    program.getDirtyWords( ).add(dirtyWord);
                }
                for (Classification classification : classifications)
{
    classification.getPrograms( ).add(program);
                }
            }
        }
        access.setClassifications(classifications);
        SafeJiveLog.info(“Done retrieving Access for ” + username);
        return access;
    }
}
```

### B.2 MessageClassificationFilter

A MessageClassificationFilter performs the marking of instant message packets with classification information based on the current selection by the user. The current selection by the user depends on which checkboxes he has selected, indicating the collateral classification level, the applicable compartments, programs, etc.

```
public class MessageClassificationFilter implements MessageFilter {
    private ChatRoom chatRoom;
    private ImprovedClassificationPanel classificationPanel;
    public MessageClassificationFilter(ChatRoom chatRoom,
            ImprovedClassificationPanel classificationPanel) {
        this.setChatRoom(chatRoom);
        this.setClassificationPanel(classificationPanel);
    }
    public void filterOutgoing(ChatRoom chatRoom, Message
message) {
        if (chatRoom == this.getChatRoom( )) {
            Classification selectedClassification = this
    .getClassificationPanel( ).getSelectedClassification( );
            StringBuffer newMessageSB = new StringBuffer( );
            newMessageSB.append(“(”);
    newMessageSB.append(selectedClassification.getCode( ));
            for (Program program :
selectedClassification.getPrograms( )) {
                newMessageSB.append(“/”);
                newMessageSB.append(program.getCode( ));
            }
            newMessageSB.append(“) ”);
            newMessageSB.append(message.getBody( ));
            message.setBody(newMessageSB.toString( ));
            message.addExtension(new
PacketClassificationExtension(
                    selectedClassification));
        }
    }
    public void filterIncoming(ChatRoom chatRoom, Message
message) {
        PacketExtension packetExtension = message.getExtension(
                PacketClassificationExtension.getElemName( ),
    PacketClassificationExtension.getElemNamespace( ));
        if (packetExtension != null) {
            PacketClassificationExtension
messageClassificationExtension = (PacketClassificationExtension)
packetExtension;
            Classification selectedClassification =
messageClassificationExtension
                    .getClassification( );
            this.getClassificationPanel( ).setSelectedClassification(
                    selectedClassification);
        }
    }
    public ChatRoom getChatRoom( ) {
        return chatRoom;
    }
    public void setChatRoom(ChatRoom chatRoom) {
        this.chatRoom = chatRoom;
    }
    public ImprovedClassificationPanel getClassificationPanel( ) {
        return classificationPanel;
    }
    public void setClassificationPanel(
            ImprovedClassificationPanel classificationPanel) {
        this.classificationPanel = classificationPanel;
    }
                        }
```

We claim:

1. A secure collaborative environment for an organization comprising a security rules engine in which access to secure information is granted or denied based on the application of an organization's security policy.

2. The environment of claim 1 wherein the security policy includes authorization criteria for users, physical and logical access locations, and computing applications, as well as descriptive security details of the target information.

3. A method for selectively granting access to data in an application based on the comparison of item interests.

4. The method of claim 3 wherein comparison of item interests is controlled through the application of rules to allow, restrict or deny interaction between item interests.

5. The method of claim 3 where item interaction is controlled by the application of interests to items.

6. The method of claim 3 wherein information that defines a logical limitation of need to share is applied to an item interest.

7. The method of claim 3 wherein interests are applied to items.

8. The method of claim 4 wherein interests are applied to items.

9. The method of claim 3 where the logical union of a user's interest is less that the interest of the requested data or communication transaction with another user.

10. The method of claim 3 wherein the application is a content management system.

11. The method of claim 10 that provides for reduced or restricted searching, browsing, and storing of data.

12. The method of claim 3 wherein items with interest for uses may be marked.

13. The method of claim 3 further comprising dirty word searches for submitted content items by interest.

14. The method of claim 3 further comprising streaming context based search of submitted content items.

15. The method of claim 3 wherein the application is a messaging system.

16. The method of claim 15 that allows for marking messages with interests for users.

17. The method of claim 15 that allows for dirty word searches for submitted messages between items by interest.

18. The method of claim 15 that allows for streaming context based search of submitted messages between items.

19. The method of claim 15 further comprising streaming context based search of messages.

20. The method of claim 3 wherein the application is a collaboration tool.

21. The method of claim 20 further comprising marking of session with interests for users.

22. The method of claim 20 further comprising dirty word searches for sessions between items of interest.

23. The method of claim 20 further comprising streaming context based search of content between items.

24. The method of claim 3 wherein the interests are applied to items where the items are produced through desktop productivity software.

25. The method of claim 24 wherein the items are Adobe.pdf content.

26. The method of claim 24 wherein the items are Adobe.pdf forms.

27. The method of claim 24 wherein the items are OpenOffice content.

28. The method of claim 24 wherein the items are Microsoft Office content.

29. The method of claim 24 wherein the items are messages between items.

30. The method of claim 24 wherein dirty word searches are applied to items.
